(19) United States
(12) Patent Application Publication
(10) Pub. No.: US 2026/0167191 A1
(43) Pub. Date: Jun. 18, 2026

(54) VEHICLE AND METHOD FOR CONTROLLING THE SAME

(71) Applicants: Hyundai Motor Company, Seoul (KR); Kia Corporation, Seoul (KR)

(72) Inventors: Jong Chul KIM, Hwaseong-Si (KR); Eun Young CHOI, Hwaseong-Si (KR); Su Hyun KIM, Hwaseong-Si (KR); Byoung Joon LEE, Hwaseong-Si (KR); Dong Eon OH, Hwaseong-Si (KR)

(21) Appl. No.: 19/333,953

(22) Filed: Sep. 19, 2025

(30) Foreign Application Priority Data
Dec. 13, 2024 (KR) 10-2024-0186196

(51) Int. Cl. B60W 30/165; B60R 1/24; B60W 50/14; B60W 60/00

(52) U.S. Cl. CPC B60W 30/165; B60W 50/14; B60W 60/00274; B60R 1/24; B60R 2300/304; B60R 2300/307; B60W 2050/146; B60W 2554/4041; B60W 2554/4042; B60W 2554/4043; B60W 2554/4046; B60W 2554/802

(57) ABSTRACT

An apparatus of a vehicle may comprise a processor and a memory storing at least one instruction that, when executed by the processor communicating with the memory, is configured to cause the apparatus to identify, via a sensor of the vehicle, a preceding vehicle, wherein the preceding vehicle corresponds to a target object for the vehicle to follow during autonomous driving of the vehicle, create, based on driving information of the identified preceding vehicle, a virtual object associated with the preceding vehicle, output a signal indicating the preceding vehicle and the created virtual object, and control, based on the signal, autonomous driving of the vehicle.

### CROSS-REFERENCE TO RELATED APPLICATION

This application claims the benefit of priority to Korean Patent Application No. 10-2024-0186196, filed in the Korean Intellectual Property Office on Dec. 13, 2024, the disclosure of which is incorporated herein by reference in its entirety.

### TECHNICAL FIELD

Various examples of the present disclosure relate to a technology for operating control of following a preceding vehicle in a more efficient manner among controls in a vehicle system.

### BACKGROUND

The matters described in this Background section are only for enhancement of understanding of the background of the disclosure, and should not be taken as acknowledgment that they correspond to prior art already known to those skilled in the art.

In an autonomous driving system, a function of allowing a vehicle to follow a preceding vehicle in real time to maintain the stability of driving may be provided. In this following function, a safe distance between vehicles may be maintained and a speed may be adjusted based on driving information of the preceding vehicle.

However, a forward following system may be designed based on the assumption that a driving state of a preceding vehicle is normal and thus has the limitation of not being able to respond appropriately when the preceding vehicle exhibits an abnormal behavior such as rapid acceleration or sudden deceleration or irregular lane changes.

In such forward following system, when an autonomous driving vehicle follows a preceding vehicle as it is, the stability of driving may deteriorate due to repetition of unnecessary acceleration and deceleration or an increase in the risk of collision.

### SUMMARY

The present disclosure has been made to solve the aforementioned problems and is directed to detecting an abnormal behavior of a preceding vehicle and providing a virtual object to replace the preceding vehicle of which the abnormal behavior is detected.

The problems to be solved by the present disclosure are not limited to the problems that are mentioned above, and other problems that have not been mentioned can be clearly understood by those skilled in the art from the description below.

According to the present disclosure, an apparatus of a vehicle, the apparatus may comprise, a processor, and a memory storing at least one instruction that, when executed by the processor communicating with the memory, is configured to cause the apparatus to, identify, via a sensor of the vehicle, a preceding vehicle, wherein the preceding vehicle corresponds to a target object for the vehicle to follow during autonomous driving of the vehicle, create, based on driving information of the identified preceding vehicle, a virtual object associated with the preceding vehicle, output a signal indicating the preceding vehicle and the created virtual object, and control, based on the signal, autonomous driving of the vehicle.

The apparatus, wherein the at least one instruction, when executed by the processor communicating with the memory, is configured to cause the apparatus to create, based on a determination that the preceding vehicle is abnormally behaving, the virtual object. The apparatus, wherein the at least one instruction, when executed by the processor communicating with the memory, is configured to cause the apparatus to, based on a determination that the preceding vehicle is abnormally behaving for a predetermined time or longer, create the virtual object.

The apparatus, wherein the at least one instruction, when executed by the processor communicating with the memory, is configured to cause the apparatus to, control the vehicle so that one of the preceding vehicle or the virtual object is followed by the vehicle, and control a display of the vehicle so that the one of the preceding vehicle or the virtual object followed by the vehicle and an indicator indicating that the one of the preceding vehicle or the virtual object is a current following target of the vehicle are is displayed on the display.

The apparatus, wherein the at least one instruction, when executed by the processor communicating with the memory, is configured to cause the apparatus to, based on the preceding vehicle being a predetermined distance away from the vehicle, control the vehicle so that the vehicle follows the virtual object.

The apparatus, wherein the at least one instruction, when executed by the processor communicating with the memory, is configured to cause the apparatus to, based on the preceding vehicle being within a predetermined distance from the vehicle, control the vehicle so that the vehicle follows the preceding vehicle.

The apparatus, wherein the at least one instruction, when executed by the processor communicating with the memory, is configured to cause the apparatus to, based on the preceding vehicle being within a predetermined distance from the vehicle, delete the virtual object. The apparatus, wherein the at least one instruction, when executed by the processor communicating with the memory, is configured to cause the apparatus to, detect at least one of, a change in speed of the preceding vehicle, a change in acceleration of the preceding vehicle, or a change in distance between the vehicle and the preceding vehicle, and determine, based on the at least one of the detected changes exceeding a preset value, that the preceding vehicle is abnormally behaving.

The apparatus, wherein the least one instruction, when executed by the processor communicating with the memory, is configured to cause the apparatus to, based on a determination that the vehicle is abnormally behaving, output a warning through a user interface of the vehicle. The apparatus, wherein the at least one instruction, when executed by the processor communicating with the memory, is configured to cause the apparatus to, based on a determination that the vehicle is abnormally behaving, highlight the preceding vehicle on a display of the vehicle.

The apparatus, wherein the least one instruction, when executed by the processor communicating with the memory, is configured to cause the apparatus to simultaneously display, on a display of the vehicle, the preceding vehicle and the virtual object. The apparatus, wherein the least one instruction, when executed by the processor communicating with the memory, is configured to cause the apparatus to display, on a display of the vehicle, the preceding vehicle and the virtual object in distinct forms.

The apparatus, wherein the virtual object is configured to exhibit reduced motion of the preceding vehicle with respect to at least one of longitudinal motion or lateral motion of the preceding vehicle. The apparatus, wherein the virtual object is configured to exhibit less motion in a decelerating direction of the preceding vehicle than in an accelerating direction of the preceding vehicle.

According to the present disclosure, a method performed by an apparatus of a vehicle, the method may comprise, identifying, via a sensor of the vehicle, a preceding vehicle, wherein the preceding vehicle corresponds to a target object for the vehicle to follow during autonomous driving of the vehicle, creating, based on driving information of the identified preceding vehicle, a virtual object associated with the preceding vehicle, outputting a signal indicating the preceding vehicle and the created virtual object, and controlling, based on the signal, autonomous driving of the vehicle. The method, wherein the creating of the virtual object may comprise, based on a determination that the preceding vehicle is abnormally behaving, creating the virtual object.

The method, wherein the creating of the virtual object may comprise, based on a determination that the preceding vehicle is abnormally behaving for a predetermined time or longer, creating the virtual object. The method, further may comprise, controlling the vehicle so that one of the preceding vehicle and the virtual object is followed by the vehicle, and controlling a display of the vehicle so that the one of the preceding vehicle or the virtual object followed by the vehicle and an indicator indicating that the one of the preceding vehicle or the virtual object is a current following target of the vehicle are displayed on the display.

According to the present disclosure, a vehicle, the apparatus may comprise, a sensor configured to detect at least one external vehicles, a processor, and a memory storing at least one instruction that, when executed by the processor communicating with the memory, is configured to cause the vehicle to, identify, via the sensor, a preceding vehicle that is being autonomously followed by the vehicle, determine, based on driving information of the preceding vehicle, whether the preceding vehicle exhibits driving behavior that satisfies a condition, based on the driving behaving satisfying the condition, output a signal indicating a virtual vehicle object associated with the preceding vehicle, and based on the signal, switch control of autonomous driving of the vehicle from following the preceding vehicle to following the virtual vehicle object.

The vehicle, wherein the virtual vehicle object is configured to exhibit reduced motion compared to at least one of a longitudinal motion or a lateral motion of the preceding vehicle, such that controlling the autonomous driving of the vehicle to follow the virtual vehicle object results in reduced acceleration or deceleration of the vehicle.

### BRIEF DESCRIPTION OF THE DRAWINGS

The above and other objects, features and advantages of the present disclosure will become more apparent to those of ordinary skill in the art by describing examples thereof in detail with reference to the accompanying drawings, in which:

FIG. 1 shows an example of a vehicle according to an example.

FIG. 2 shows an example of an operation related to creation and control of a virtual object according to an example.

FIG. 3, FIG. 4, FIG. 5, FIG. 6, FIG. 7, FIG. 8, FIG. 9, FIG. 10 are illustrative diagrams of display screens displayed according to various examples.

FIG. 11 and FIG. 12 show examples of specific operations related to the creation and control of the virtual object according to the example.

FIG. 13 shows an example of a distance relationship between a preceding vehicle and a virtual object.

FIG. 14 shows an example of a display screen displayed according to an example.

FIG. 15 shows an example of a computing system (e.g., a computing device of a vehicle or any other apparatus).

### DETAILED DESCRIPTION

Hereinafter, preferred examples of the present disclosure will be described in detail with reference to the accompanying drawings.

However, the technical idea of the present disclosure is not limited to the few examples that will be described, but may be implemented in various different forms, and one or more of the components in the examples may be selectively combined or substituted and used without departing from the scope of the technical idea of the present disclosure.

Further, terms (including technical and scientific terms) used in the examples of the present disclosure may be construed as having meanings that can be generally understood by those skilled in the art to which the present disclosure belongs, unless explicitly and specifically defined and described, and meanings of terms that are commonly used, such as terms defined in a dictionary, may be construed in consideration of contextual meaning of the related art.

In addition, the terms used in the examples of the present disclosure are intended to describe the examples and are not intended to limit the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In addition, terms such as “first,” “second,” “A,” “B,” “(a),” and “(b)” may be used to describe components in the examples of the present disclosure.

These terms are only intended to distinguish the component from other components, and do not limit the nature, order, or sequence of the component.

When a component is described as being “connected,” “coupled,” or “joined” to another component, this may include not only a case where the component is directly connected, coupled, or joined to the other component, but also a case where the component is “connected,” “coupled,” or “joined” to the other component by still another component between the component and the other component.

Further, when one component is described as being formed or disposed “on or under” another component, the term “on or under” includes not only a case in which two components are in direct contact with each other, but also a case in which one or more other components are formed or disposed between the two components. In addition, when the term “on or under” is expressed, this may mean not only an upward direction but also a downward direction with respect to one component.

In various flowcharts of the present disclosure, at least some steps may be omitted or the order of the steps may be changed, and at least some of the various examples of the present disclosure may be performed at a specific point in time in each step of the flowchart. The various flowcharts of the present disclosure may be performed by at least one of a control device 100, a processor 130, and a vehicle 10. Further, redundant contents in the drawings of the present disclosure may be omitted.

“Autonomous driving system” or “driver control assistance system” mentioned in the present disclosure refers to hardware and software that can help a driver continuously control a longitudinal motion and a lateral motion of a vehicle. The driver control assistance system may be referred to as “system” in the present disclosure.

“Feature” mentioned in the present disclosure may mean a function of a specific system that helps a driver in a defined traffic scenario, situation, and system boundary.

“Dynamic control” mentioned in the present disclosure may mean performing operational and tactical functions required to move a vehicle in real time. This may include control of lateral and longitudinal motions of the vehicle, monitoring of a road environment, coping with events in a road traffic environment, operation plans, signal transmission, and the like.

“System boundaries” mentioned in the present disclosure may mean verifiable or measurable limits or conditions set by a manufacturer, and conditions that affect a system designed to help a driver, or functions of the system and the ability of the system to operate as intended, or settings within the range of the conditions.

Hereinafter, the examples will be described in detail with reference to the accompanying drawings, the same or corresponding components will be denoted by the same reference numbers throughout drawings, and redundant description thereof will be omitted.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., feature of replacing an abnormally behaving preceding vehicle with a virtual vehicle) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., feature of replacing an abnormally behaving preceding vehicle with a virtual vehicle) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., feature of replacing an abnormally behaving preceding vehicle with a virtual vehicle) described herein.

Minimum risk maneuver (MRM) operation(s) may also be controlled, for example, based on one or more features (e.g., feature of replacing an abnormally behaving preceding vehicle with a virtual vehicle) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., feature of replacing an abnormally behaving preceding vehicle with a virtual vehicle) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., feature of replacing an abnormally behaving preceding vehicle with a virtual vehicle) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An autonomous driving level and/or autonomous driving activation/deactivation may also be controlled, for example, based on one or more features (e.g., feature of replacing an abnormally behaving preceding vehicle with a virtual vehicle) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

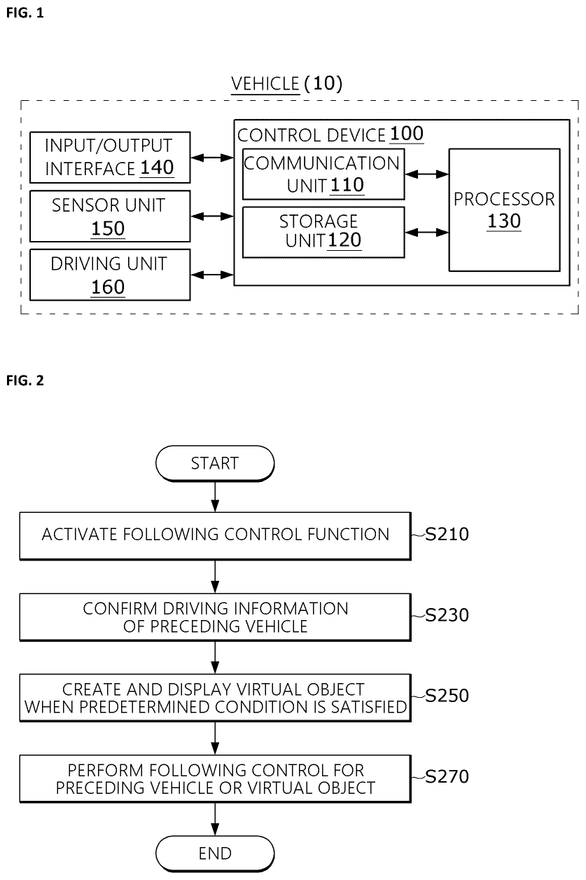

FIG. 1 shows an example of a vehicle 10 according to an example.

The vehicle 10 may include a control device 100, a communication unit 110, a storage unit 120, a processor 130, an input/output interface 140, a sensor unit 150, and a driving unit 160. Each of these components in FIG. 1 may be implemented inside the vehicle.

The control device 100 may be formed integrally with internal components of the vehicle, and may be implemented as an independent device separately from the other components inside the vehicle 10 to perform communication with the internal components of the vehicle through various connection means (for example, a CAN bus, a wireless network, and a wired connection). The control device 100 may include the communication unit 110, the storage unit 120, and the processor 130 to control the vehicle, and may further include other components such as the input/output interface 140, the sensor unit 150, and the driving unit 160 to perform a complex control function depending on a driving situation (e.g., sudden lane changes of a nearby vehicle, unexpected stop of a preceding vehicle, or detection of abnormal acceleration patterns, etc.).

The communication unit 110 may perform communication with other control devices inside the vehicle to share inter-system data or transmit or receive various types of information through a connection to the outside of the vehicle. The communication unit 110 may transmit control signals and data between the internal components using various in-vehicle communication schemes such as CAN communication and Ethernet, and may link driving information and external data in real time through communication with a user terminal, another vehicle (vehicle-to-vehicle (V2V)), infrastructure (vehicle-to-infrastructure (V2I)), or an external server (e.g., traffic control centers, cloud-based driving assistance platforms, or HD map servers, etc.).

The communication unit 110 may perform short-range communication, GPS signal reception, vehicle-to-everything (V2X) communication, optical communication, broadcast transmission and reception, and intelligent transport systems (ITS) communication functions, and may support stable data transmission in a short range using wireless communication technology such as Bluetooth, radio frequency identification (RFID), Infrared Data Association (IrDA), ultra wideband (UWB), ZigBee, near field communication (NFC), Wi-Fi, Wi-Fi Direct, and wireless USB. Further, the communication unit 110 may include a mobile communication module based on a mobile communication network (LTE, 5G, or 6G) and a wireless Internet module for access to wireless Internet to receive real-time data through long-range communication and improve the performance of the autonomous driving system in conjunction with a cloud (e.g., for receiving software updates, remote diagnostics, or hazard alerts, etc.).

The storage unit 120 may include various types of memories capable of storing data, and may be integrated into the control device 100 or the processor 130 or configured in the form of a separate module. The storage unit 120 may include a nonvolatile memory (for example, a hard disk drive, a flash memory, an EEPROM, an SRAM, an FRAM, a PRAM, or an MRAM) and a volatile memory (for example, a DRAM, an SDRAM, or a DDR-SDRAM), which may be combined to implement memory systems with various capacities and performances (e.g., to store recent sensor readings, historical driving patterns, or virtual object creation rules, etc.).

According to an example, the storage unit 120 may be configured to store driving information of the preceding vehicle, a virtual object creation criterion, and various types of data related to driving control of the vehicle 10. The storage unit 120 may store driving data collected in real time, such as a speed, acceleration, deceleration frequency, steering angle, or lane change frequency of the preceding vehicle, and provide criterion data necessary for the control device 100 to determine the abnormal behavior of the preceding vehicle (e.g., erratic braking, sudden swerving, or frequent cut-ins, etc.).

Further, the storage unit 120 may store setting values and algorithms necessary for creation of the virtual object. For example, the storage unit 120 may include an abnormal behavior threshold of the preceding vehicle, control parameters for determining the motion of the virtual object, and the like. Such data may be utilized for the control device 100 to create an appropriate virtual object according to driving situations and control the driving of the vehicle 10 based on the appropriate virtual object (e.g., using a smoothed average of prior trajectories, applying motion dampening in the deceleration direction, or adjusting lateral offset patterns, etc.).

The processor 130 may perform communication with the communication unit 110, the storage unit 120, the input/output interface 140, the sensor unit 150, the driving unit 160, and various internal components of the vehicle 10 through electrical or operational connections, and may control an operation of each component and perform data processing. The processor 130 is a central processing unit for command execution and data calculation, and may collect, process, and analyze data in real time to perform vehicle control according to a driving environment of the vehicle (e.g., urban traffic, highway cruising, or merging situations, etc.).

The processor 130 may be implemented in the form of hardware, software, or a combination thereof, and may perform vehicle control logic in the form of, for example, a microcontroller, an FPGA, or an ASIC. Further, the processor 130 may include a multi-processor configuration for controlling complex autonomous driving and a driver assistance system. Such a processor configuration may support comprehensive control and stable performance of the vehicle by executing autonomous driving and assistance systems, processing sensor data, managing communication data, and performing driving-related determinations (e.g., determining when to switch from real to virtual target following, or triggering lane change logic to avoid unstable lead vehicles, etc.).

The input/output interface 140 serves to receive input related to vehicle control from the user and transfer a vehicle control status and system operation information to the user (e.g., through touchscreens, voice command interfaces, or instrument cluster notifications, etc.).

The input/output interface 140 may perform a function of receiving various inputs from the user and transferring the vehicle control status to the user. The input/output interface 140 may include an input means and an output means.

The input means may include physical buttons, selection areas on a touch display, a voice recognition function, a gesture recognition function, a steering wheel-mounted control, and the like, and this allows the user to input commands, for example, to request activation of the autonomous driving system, switch between functions, or set driving assistance (e.g., enabling adaptive cruise control, adjusting safe following distance, or selecting virtual object following mode, etc.).

The output means includes a display, an audio module (for example, a speaker), a haptic module, and the like, and may provide the user with a status of the autonomous driving system, a control switching request notification, whether or not a function is activated, and the like in a visual, auditory, or tactile form (e.g., blinking icons, voice alerts, or steering wheel vibrations, etc.).

According to an example, the input/output interface 140 may include a display. The input/output interface 140 may visually output information on the preceding vehicle and the virtual object through the display (e.g., using different shapes, borders, or colors to distinguish between the real and virtual targets, etc.).

Further, the input/output interface 140 may provide an acoustic warning through a speaker, or may notify the driver of an abnormal situation through vibration in a seat cushion, gear shift knob, or a steering wheel using a tactile feedback device.

Further, the input/output interface 140 may receive an input from the driver through a touch screen, physical buttons such as switches, a voice recognition system, or the like. This makes it possible for the driver to transmit, for example, commands to activate an autonomous driving function, to change a warning setting, and to release a warning to the vehicle system (e.g., acknowledging a forward collision warning, canceling lane keeping assistance, or confirming a route change, etc.).

The sensor unit 150 may include a plurality of sensors that detect various types of driving and environmental information in real time to support stable operation of an autonomous driving system or a driver assistance system. The sensor unit 150 may measure a distance to and speed of a nearby object through long-range detection sensors such as radio detection and ranging (RADAR) and light detection and ranging (LiDAR), and may detect objects near the vehicle 10 by including an ultrasonic sensor (e.g., for parking assistance, blind spot detection, or close-range collision prevention, etc.).

The sensor unit 150 may include a camera. The camera can be classified into an external camera and an internal camera. The external camera may recognize a road and a surrounding environment (e.g., lane markings, traffic lights, pedestrians, or nearby vehicles, etc.), and the internal camera may detect a driver's state (for example, eye tracking or a steering wheel grip state) or an interior situation to comprehensively ascertain situations inside and outside the vehicle. The sensor unit 150 may include a heart rate sensor, a pressure sensor, an infrared sensor, and the like to collect the driver's biometric information or various types of environmental data (e.g., cabin temperature, driver fatigue level, or drowsiness detection, etc.).

According to an example, the sensor unit 150 may detect, for example, a speed, acceleration, distance, relative velocity, or lane change behavior of the preceding vehicle using devices such as RADAR, LiDAR, ultrasonic sensors, and cameras. The sensors may detect a position and driving state of the preceding vehicle and provide data necessary for the control device 100 to determine whether the preceding vehicle exhibits an abnormal behavior. For example, the RADAR may detect a distance and relative speed between the preceding vehicle and the vehicle 10, and the camera may recognize whether the preceding vehicle is changing lanes or rapidly accelerating/decelerating (e.g., sudden merging, frequent cut-ins, or inconsistent speed bursts, etc.).

The driving unit 160 may include various components that provide drive power required for driving of the vehicle 10 and control the operation of the vehicle according to a command output from the control device 100. The driving unit 160 may be configured of devices that generate and transfer power for the vehicle, such as an engine, a motor, a transmission, and a wheel drive system, and a controller that controls the devices, and acceleration, deceleration, and direction change of the vehicle 10 may be performed through such components (e.g., front-wheel drive, rear-wheel drive, or all-wheel drive configurations, etc.).

The driving unit 160 is controlled to be able to maintain driving safety by performing longitudinal control (acceleration and deceleration) and lateral control (lane maintenance and change) of the vehicle. For example, the driving unit 160 receives a command from the control device 100 and adjusts an output of the motor or a rotation speed and direction of wheels so that the vehicle can travel along a driving route (e.g., maintaining a center of the lane, merging into traffic, or adjusting speed to match a virtual target, etc.).

Further, the driving unit 160 may include a brake system to reduce a speed of the vehicle or stop the vehicle during driving. The driving unit 160 may control the vehicle 10 based on control through an electric motor in the case of an electric vehicle or based on an engine output in the case of an internal combustion engine vehicle (e.g., hybrid, plug-in hybrid, or battery electric configurations, etc.).

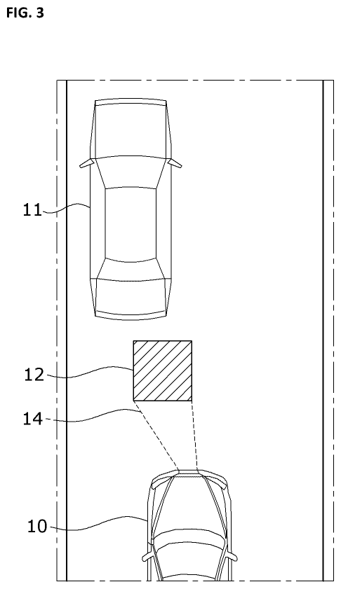

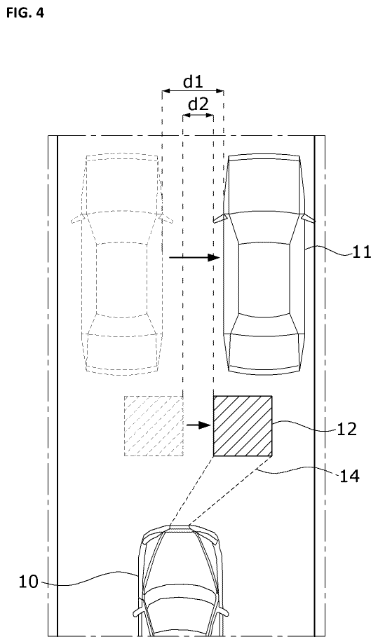

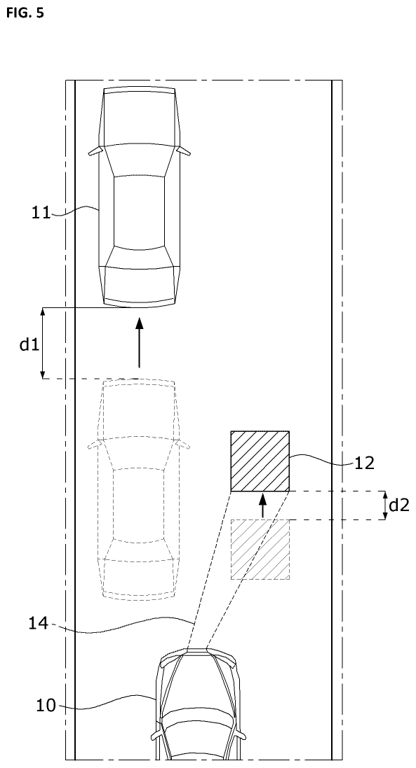

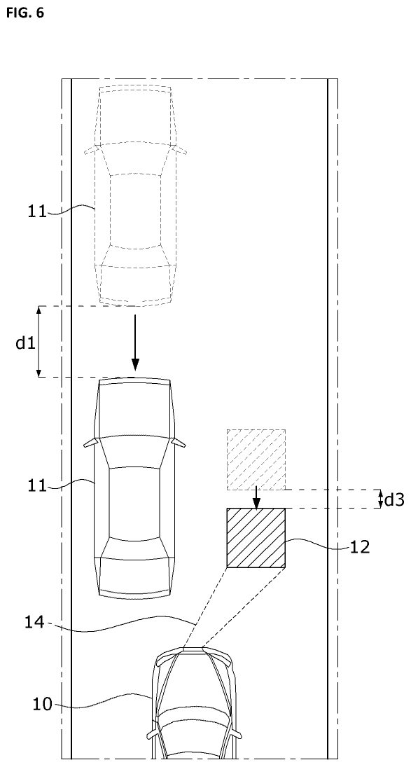

FIG. 2 shows an example of an operation related to the creation and control of a virtual object according to an example. For description of FIG. 2, reference will be made to FIGS. 3 to 10. FIGS. 3 to 10 are illustrative diagrams of display screens displayed according to various examples. Sizes and shapes of the display screens in FIGS. 3 to 10 may be changed into various sizes and shapes depending on the input/output interface of the vehicle 10 (e.g., cluster display, head-up display, or central infotainment screen, etc.).

The control device 100 may activate a following control function for following a preceding vehicle according to an autonomous driving function of the vehicle 10 (S210).

Specifically, the control device 100 is capable of executing following control logic for controlling a speed, direction, acceleration, deceleration, and braking state of the vehicle 10 in real time. The following control function may be activated when a driving mode of the vehicle 10 is set to an autonomous driving mode, and thus a preceding vehicle to follow may be detected.

For example, when the vehicle 10 is driving in the autonomous driving mode, the control device 100 may detect a preceding vehicle (for example, a forward vehicle) through the sensor unit 150 such as a front RADAR and camera of the vehicle. The control device 100 may confirm a driving speed of the preceding vehicle and a longitudinal distance between the preceding vehicle and the vehicle 10 and activate the following control function. When the following control function is activated, the control device 100 adjusts the speed of the vehicle 10 according to the speed of the preceding vehicle and outputs a braking command to maintain a safe distance as necessary (e.g., increasing gap when detecting erratic leading behavior or decelerating smoothly when the preceding vehicle slows down, etc.).

Next, the control device 100 may confirm driving information related to a vehicle in front of the vehicle 10 (S230).

The control device 100 may collect and analyze the driving information of the preceding vehicle in real time by utilizing the sensor unit 150 mounted on the vehicle 10, such as at least one of a front camera, RADAR, and LiDAR (e.g., mono or stereo camera, millimeter-wave RADAR, or rotating/microelectromechanical LiDAR, etc.).

The confirmed driving information may include information on a position, speed, acceleration, distance, driving direction, and lane change state of the preceding vehicle, but is not limited thereto. The control device 100 may process collected data to ascertain a current state and motion of the preceding vehicle, and generate basic data for creation of a virtual object or forward following control of the vehicle 10 (e.g., using filtered velocity vectors, movement history buffers, or projected trajectories, etc.).

Next, the control device 100 may create the virtual object if a predetermined condition is satisfied, and display the created virtual object (S250).

According to an example, the control device 100 may analyze driving information such as a behavioral state and driving environment of the preceding vehicle and create the virtual object if a predetermined condition is satisfied. The virtual object may be created to provide a safe following target that replaces the preceding vehicle when stable driving control of the vehicle 10 is difficult due to detected abnormal behavior of the preceding vehicle.

According to an example, the predetermined condition may include a case in which the abnormal behavior of the preceding vehicle is detected (e.g., frequent rapid braking, erratic lane weaving, or oscillatory stop-and-go patterns, etc.).

The abnormal behavior may be defined as an abnormal motion of the preceding vehicle that deviates from a normal driving pattern and affects stable driving control of the autonomous driving vehicle 10. Such an abnormal behavior may interfere with maintenance of a safe distance between vehicles and a predictable driving trajectory. The control device 100 may generate a determination criterion for the abnormal behavior by utilizing driving data of previous vehicles that have driven on a road (e.g., via moving averages, variance thresholds, or frequency-based anomaly scoring, etc.).

The control device 100 may display the virtual object created according to detection of the abnormal behavior through a display included in the input/output interface 140 of the vehicle 10. For example, referring to FIG. 3, the vehicle 10, the preceding vehicle 11, and a virtual object 12 are shown through the display in distinguishable visual formats (e.g., solid vs. dashed outline, color differences, or icon overlays, etc.).

The control device 100 may confirm the driving information of the preceding vehicle 11 through the sensor unit 150 and compare the confirmed driving information with an abnormal behavior determination criterion stored in a memory of the storage unit 120. If the preceding vehicle 11 is determined to satisfy the abnormal behavior determination criterion, the control device 100 may create the virtual object 12 of FIG. 3.

The control device 100 may create the abnormal behavior determination criterion through statistical analysis or a learning-based approach and determine whether or not a behavior of the preceding vehicle is an abnormal behavior based on the driving information (longitudinal distance, lateral distance, speed, acceleration, and the like) of the preceding vehicle. For example, if a change in the speed of the preceding vehicle exceeds a specific threshold value compared to an average or an acceleration pattern deviates from a statistical deviation, the behavior of the preceding vehicle may be determined to be an abnormal behavior (e.g., sudden surges, abrupt halts, or swaying motion, etc.).

To this end, the control device 100 may collect preceding vehicle data in real time, periodically, or at any point in time, and compare the preceding vehicle data with the abnormal behavior determination criterion to identify abnormal motions. The control device 100 may analyze key indicators such as the longitudinal distance, the lateral distance, the speed, and the acceleration in this process, and determine the preceding vehicle to be an abnormally behaving vehicle if a specific condition is satisfied (e.g., sustained deviation from moving average, large variance spikes, or high-frequency oscillation, etc.). For example, if the preceding vehicle rapidly decelerates, repeatedly changes lanes, or shows an irregular trajectory, the control device 100 may determine the preceding vehicle to be an abnormally behaving vehicle (e.g., in stop-and-go traffic, weaving through lanes, or brake-checking scenarios, etc.).

For example, the control device 100 may collect the driving information of the preceding vehicle in real time, and analyze the driving information based on an average value and a standard deviation σ of previous driving data to perform an abnormal behavior determination. The criterion for determining an abnormal behavior may be set as a case in which a predetermined value (for example, 1.5σ) compared to an average value in the previous driving data is exceeded. In this case, analysis items may include, for example, a speed change amount, an acceleration change amount, and an acceleration change rate of the preceding vehicle, but are not limited to (e.g., yaw rate shifts, jerk rate, or lateral deviation metrics, etc.).

For example, when the abnormal behavior determination is made depending on the speed change amount, if an average speed change is 10 km/h and the standard deviation σ is 3 km/h in the previous driving data, the abnormal behavior threshold may be set to 14.5 km/h (10+1.5σ). In this case, when the speed of the preceding vehicle increases from 0 km/h to 16 km/h within 5 seconds, the speed change amount exceeds 14.5 km/h, and thus the behavior of the preceding vehicle may be determined to be an abnormal behavior.

According to an example, if the abnormal behavior of the preceding vehicle is detected for a predetermined period of time or longer, the control device 100 may create a virtual object corresponding to the preceding vehicle (e.g., when erratic lane weaving persists for 3 seconds or more, or repeated start-stop cycles last beyond a threshold window, etc.).

For example, when the preceding vehicle repeatedly stops and starts suddenly at short intervals of a predetermined period of time (for example, two seconds) or longer, or continuously performs lane changes within a predetermined period of time and thus exhibits an unstable trajectory, the control device 100 may determine the preceding vehicle to be an abnormally behaving vehicle.

If such a pattern is not resolved within a predetermined period of time, the control device 100 may create a virtual object that replaces the preceding vehicle. This makes it possible to selectively detect a continuous repetitive abnormal behavior, rather than a temporary abnormal behavior (e.g., due to a momentary obstruction or transient deceleration, etc.).

According to an example, when the abnormal behavior of the preceding vehicle is detected, the control device 100 may output a warning through the input/output interface 140. This makes it possible for the driver to immediately recognize an abnormal motion of the preceding vehicle (e.g., sudden braking, swerving, or aggressive acceleration, etc.).

For example, if the abnormal behavior of the preceding vehicle is detected, the control device 100 may provide a visual warning through a display of the vehicle 10. The visual warning may be output in a manner that highlights the preceding vehicle (for example, as a blinking icon) or by outputting a text message such as “Warning: an abnormal behavior of the preceding vehicle has been detected.” (e.g., displayed in a red box, pulsing effect, or top-bar alert format, etc.)

According to an example, if the abnormal behavior of the preceding vehicle is detected, the control device 100 may highlight the preceding vehicle through the display. For example, if the preceding vehicle exhibits the abnormal behavior, the control device 100 may display the preceding vehicle as a blinking icon on the display or add a blinking warning border around the preceding vehicle for visual delivery to the driver (e.g., using a red outline, animated halo, or color inversion effect, etc.).

Further, the warning may be output through an acoustic signal. For example, a warning sound or a notification sound may be output to draw a driver's attention (e.g., a double-beep tone, escalating pitch sequence, or synthetic voice alert, etc.). An acoustic warning and a visual warning may be output together, or may be operated independently in a situation in which the driver cannot directly confirm the display (e.g., when the driver is wearing sunglasses that obscure a HUD, or looking away from the cluster, etc.).

Further, the warning may be output through a vibration signal. For example, if the abnormal behavior is detected, the control device 100 may deliver the warning by outputting vibration through the steering wheel (e.g., a short buzz pattern, pulsed tapping, or directional haptic cue, etc.).

According to an example, the control device 100 may simultaneously display the preceding vehicle and the virtual object through the display.

For example, the control device 100 may visually display a current location and state of the preceding vehicle 11 through the display and simultaneously display the virtual object 12 that replaces the preceding vehicle 11, as illustrated in FIG. 3 (e.g., shown side by side, partially overlapping, or at offset positions with labels, etc.).

According to an example, the virtual object displayed on the display may be displayed distinctly from the preceding vehicle.

For example, the virtual object may be displayed with a different color, size, shape, or transparency from the preceding vehicle. For example, the preceding vehicle 11 in FIG. 3 may be highlighted with a dotted border or a first color, while the virtual object 12 may be displayed with a solid border or a second color (e.g., blue for the real vehicle and green for the virtual object, or semi-transparent vs. opaque icons, etc.).

The control device 100 may display an indicator 14 indicating that the virtual object 12 is currently being followed. The indicator 14 may be used to intuitively convey a current following target of the vehicle 10 to the driver (e.g., an arrow pointing to the followed object, a label such as “Target,” or a glow effect around the selected object, etc.). This indicator 14 may be displayed with the same function in the drawings to be described below. This makes it possible for the driver to intuitively confirm a target (the preceding vehicle or the virtual object) that the vehicle 10 is currently following through the display.

The virtual object may be created based on the driving information of the preceding vehicle and may be set to have a stable lateral or longitudinal motion that can replace the motion of the preceding vehicle (e.g., smoothed trajectory line, delay-compensated path, or dampened turn radius, etc.).

According to an example, the virtual object may be formed to have reduced motion compared to at least one of the longitudinal or lateral motion of the preceding vehicle. This makes it possible to reduce an influence of the abnormal behavior of the preceding vehicle on the stability of driving of the vehicle 10, and to perform predictable and safe driving control (e.g., by avoiding jittery stop-start reactions or lateral swaying responses, etc.).

For example, referring to FIG. 4, when the preceding vehicle 11 moves a distance d1 in a lateral direction, the virtual object 12 may move on the display a distance d2 in the same direction. In this case, d2 may be a distance smaller than d1 (e.g., d1=1.2 m, d2=0.6 m, representing a filtered lane offset response, etc.).

Further, the virtual object may be set to have a smaller motion in a direction of longitudinal deceleration than longitudinal acceleration, thereby preventing unnecessary rapid acceleration and maintaining a safe distance (e.g., to avoid overshooting during erratic lead-vehicle braking or phantom stop signals, etc.).

For example, referring to FIG. 5, when the preceding vehicle 11 accelerates in a longitudinal direction and moves the distance d1, the virtual object 12 may move the distance d2 in the same direction on the display (e.g., with d2 being 80% of d1 to smooth sudden acceleration spikes, etc.).

Thereafter, in FIG. 6, when the preceding vehicle 11 decelerates in the longitudinal direction and moves the distance d1 again, the virtual object 12 may move a distance d3 in the same direction on the display. In this case, the distance d3 in FIG. 6 may be set to be smaller than the distance d2 in FIG. 5 (e.g., d3<d2<d1, to prioritize safe following and minimize hard braking reactions, etc.).

The reduction in the motion of the virtual object as described above may be dynamically adjusted according to a driving situation and environment. For example, the control device 100 may apply a motion primarily based on deceleration in a congested section automatically or through a user input to set the virtual object (e.g., increasing dampening factors in urban traffic or stop-and-go conditions, etc.).

According to an example, if an area in which at least a part of a preceding vehicle area and at least a part of a virtual object area overlap occurs on the display, the control device 100 may control the display so that an area of a target currently being followed by the vehicle 10 is preferentially displayed in the overlapping area (e.g., by highlighting the followed object with stronger contrast or overlay priority, etc.).

Further, the control device 100 makes an area of a target not being followed by the vehicle 10 invisible (hidden) in the overlapping area so that the driver can recognize a current following target of the vehicle (e.g., hiding the unused path marker or fading out the non-selected object, etc.).

For example, referring to FIG. 7, a situation in which an overlapping area occurs between the preceding vehicle 11 and the virtual object 12 on the display may be confirmed. In this case, the control device 100 may detect that the vehicle 10 is set to follow the virtual object 12, and control the display so that the display preferentially displays the virtual object 12 in the overlapping area (e.g., with brighter outline, thicker border, or label such as “Target Vehicle,” etc.).

As an additional example, the control device 100 may process the display of the overlapping area by highlighting the virtual object 12 in the overlapping area on the display or lowering the transparency of the virtual object 12 in the overlapping area to increase visibility (e.g., using a bold outline, pulsing glow, or increased brightness, etc.).

On the other hand, an area of the preceding vehicle 11 that is not the following target may be displayed with high transparency or completely hidden in the overlapping area (e.g., dimmed to 20% opacity or removed from the render stack, etc.).

According to an example, the control device 100 may control the vehicle 10 so that the vehicle 10 follows the preceding vehicle when the preceding vehicle approaches the vehicle 10 within a predetermined distance. This is intended to minimize the risk of collision between the vehicle 10 and the preceding vehicle 11 and maintain a safe driving distance (e.g., when a cut-in vehicle unexpectedly decelerates within close range, etc.).

For example, referring to FIG. 8, a minimum distance 13 defined as a predetermined distance from the vehicle 10 is illustrated. This minimum distance 13 is set as a minimum distance for safe driving of the vehicle 10 and may or may not be displayed on the display (e.g., as a shaded buffer zone, a numeric gap indicator, or a dynamic circle around the ego vehicle, etc.).

When a rearmost area 11a of the preceding vehicle 11 is within the minimum distance 13, the vehicle 10 is likely to be exposed to a risk of collision (e.g., due to sudden braking or abrupt merging by the preceding vehicle, etc.).

Therefore, in this situation, the control device 100 may stop following the virtual object 12 and set the preceding vehicle 11 as the following target to control the vehicle 10. When the following control for the preceding vehicle 11 is activated, the control device 100 may continuously monitor a longitudinal distance between the vehicle 10 and the preceding vehicle 11, and output the braking command as needed to secure an inter-vehicle distance (e.g., triggering adaptive cruise control fallback, initiating smooth deceleration, or activating forward collision mitigation logic, etc.).

Although a case in which the preceding vehicle 11 is within the minimum distance 13 has been described as an example in FIG. 8, a case in which the virtual object 12 is within the minimum distance 13 may also be included as a condition for a following target change to the preceding vehicle 11 in some cases (e.g., to synchronize with actual road conditions or override virtual prediction lag, etc.).

According to an example, the control device 100 may control the display so that the display displays at least a part of the preceding vehicle and at least a part of the virtual object.

For example, it can be confirmed from FIG. 9 that the partial area 11a of the preceding vehicle 11 and a partial area 12a of the virtual object 12 are displayed on the display. The partial areas 11a and 12a may be, for example, the rearmost areas of the preceding vehicle 11 and the virtual object 12 (e.g., tail edge indicators, last detected points, or boundary boxes at vehicle endpoints, etc.).

The partial areas 11a and 12a may function as minimum areas that differentiate respective positions of the preceding vehicle 11 and the virtual object 12 and enable the distance from the vehicle 10 to be visually confirmed (e.g., using bounding edges, rear bumpers, or last detected centroid markers, etc.). The partial areas 11a and 12a may provide the driver with key data necessary for the vehicle 10 to stably ascertain a current situation while minimizing unnecessary information exposure (e.g., by avoiding full-object rendering during limited display space or high-speed scenarios, etc.).

In this case, the indicator 14 may also be set to point to a partial area of a target that the vehicle 10 is currently following. As in FIG. 9, when the virtual object 12 is a current following target, the indicator 14 may be output in a manner that emphasizes or points to the rearmost area 12a of the virtual object (e.g., using an animated arrow, pulsing dot, or direction line with a label, etc.).

Further, in FIG. 9, the control device 100 may display the partial areas 11a and 12a of the two objects differently on the display in order to distinguish the positions of the preceding vehicle 11 and the virtual object 12. For example, the partial areas 11a and 12a may be displayed in different colors or with different transparency. For example, the partial area 11a of the preceding vehicle 11 may be displayed with a solid border, and the partial area 12a of the virtual object 12 may be displayed with a dotted border (e.g., red solid line for real vehicle vs. green dashed line for virtual object, etc.). In addition, text information for the current following target (e.g., “Current following target: Virtual object” or “Now following: Real vehicle”) may be additionally output on the display.

FIG. 10 illustrates an example in which a shape of the indicator 14 is different from that in FIG. 9. As illustrated in FIG. 10, the indicator 14 may be displayed in a straight shape (for example, an arrow) in order to more easily display a distance to a control target (e.g., pointing from the ego vehicle to the tail of the followed object, with variable length indicating real-time gap, etc.).

The virtual object may be updated in real time even after being created and displayed once, and information displayed on the display may be dynamically changed depending on driving conditions of the vehicle 10 and a change in state of the preceding vehicle. For example, when it is detected that the abnormal behavior of the preceding vehicle has been resolved and the preceding vehicle has returned to a normal driving state, the control device 100 may delete the virtual object from the display and reset the preceding vehicle as the following target (e.g., transitioning back to the real vehicle view with a brief fade animation or status label update, etc.).

The control device 100 may control the vehicle 10 so that the vehicle 10 follows the preceding vehicle or the virtual object (S270).

The control device 100 may dynamically determine the following target based on the driving state of the preceding vehicle and whether the virtual object is created (e.g., switching from virtual to real if the preceding vehicle stabilizes, or vice versa if erratic behavior resumes, etc.).

For example, when the preceding vehicle is driving normally, the control device 100 may control the vehicle 10 so that the vehicle 10 follows the preceding vehicle. The control device 100 may control the vehicle 10 so that the vehicle 10 can perform smooth following driving, by synchronizing its speed and direction while maintaining a safe distance from the preceding vehicle (e.g., using adaptive cruise control tuned to the real-time traffic flow, etc.). On the other hand, if the preceding vehicle exhibits an abnormal behavior, the control device 100 may create the virtual object, set the virtual object as a new following target, and control the vehicle 10 accordingly (e.g., reducing acceleration aggressiveness or extending time headway when following the virtual object, etc.).

In a following control process, a speed and acceleration of the vehicle 10 and lane locations may be adjusted in real time so that the vehicle 10 can stably follow the following target within a certain distance (e.g., 2-3 seconds headway or 20-30 meters based on speed, etc.). For example, when the preceding vehicle or the virtual object decelerates, the control device 100 may reduce the speed of the vehicle 10 to maintain the safe distance (e.g., by releasing the throttle, applying regenerative braking, or issuing a mild braking command, etc.). On the other hand, when the following target accelerates, the vehicle 10 may accelerate so that the vehicle 10 can follow the following target while avoiding unnecessary rapid acceleration (e.g., applying a smooth ramp-up profile or maintaining comfort-based acceleration thresholds, etc.).

According to an example, the control device 100 may assign a visual priority to an object (for example, the virtual object) that is a current following target. For example, the virtual object that is the following target may be displayed with a brighter color or with higher saturation or brightness than the preceding vehicle (e.g., a glowing blue overlay vs. a dim gray silhouette, etc.). For example, the virtual object that is the following target may be highlighted in a blinking form (e.g., with a pulsing outline or flashing animation at a fixed rate, etc.).

The control device 100 may also provide additional information so that the driver can recognize a target being currently followed by the vehicle 10 on the display. For example, the display may output text such as “Current following target: Virtual object” or “Current following target: Preceding vehicle,” or additionally display an icon on the following target between the two objects (e.g., a checkmark, a radar cone, or a trailing arrow symbol, etc.).

According to an example, the control device 100 may provide, through the input/output interface 140, a selection option for setting whether to follow a virtual object as needed. For example, the control device 100 may provide a selectable option such as “Activate virtual object following” or “Maintain preceding vehicle following,” and control the vehicle 10 so that the vehicle 10 follows a target selected according to a driver's input (e.g., using touchscreen buttons, rotary knobs, or voice commands, etc.).

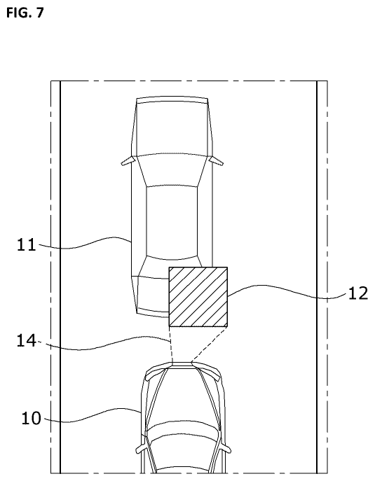

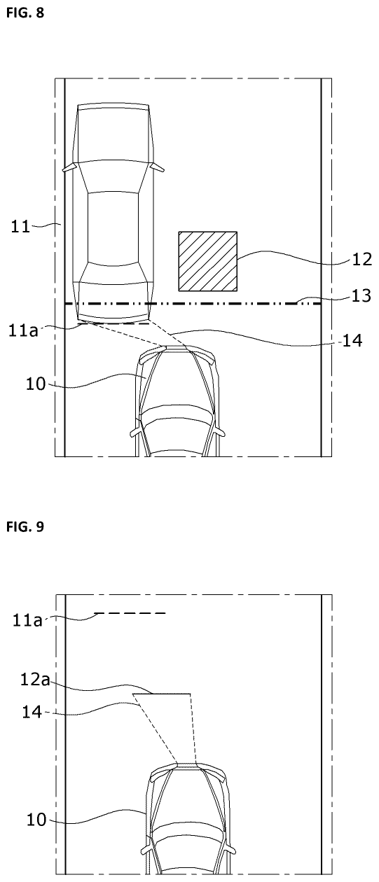

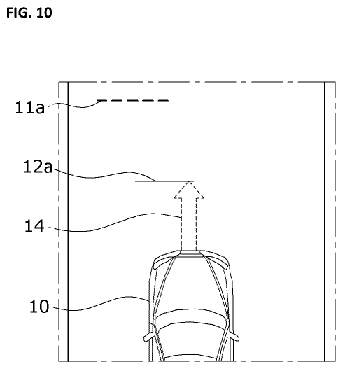

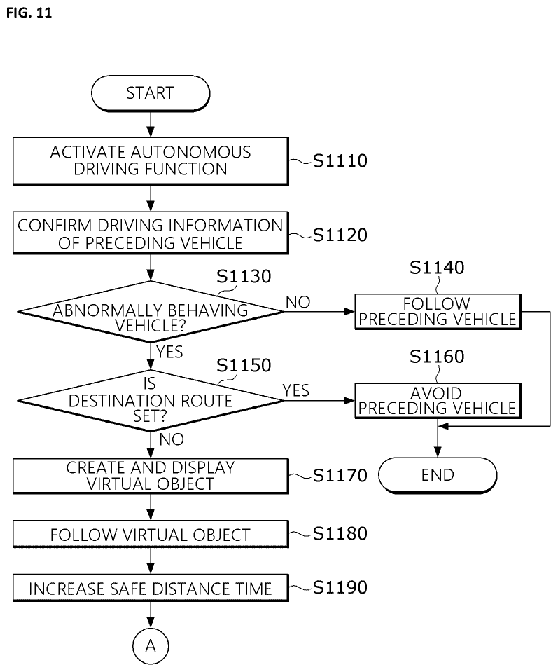

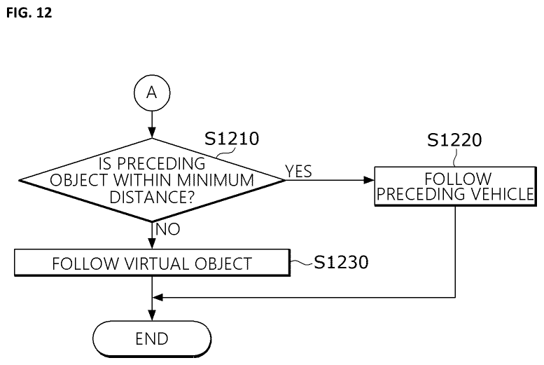

FIGS. 11 and 12 show examples of specific operations related to the creation and control of the virtual object according to the example. Content of FIGS. 11 and 12 that overlaps that of FIG. 2 may be omitted (e.g., initial driving detection, sensor activation, or previously described determination steps, etc.).

The control device 100 may activate autonomous driving (S1110) and confirm the driving information of the preceding vehicle (S1120). The control device 100 may determine whether the preceding vehicle is an abnormally behaving vehicle (S1130) (e.g., based on thresholds for erratic lane changes, sudden stops, or oscillating speed patterns, etc.).

If the preceding vehicle is not an abnormally behaving vehicle (S1130: No), the control device 100 may control the vehicle 10 so that the vehicle 10 follows the preceding vehicle (S1140).

On the other hand, if the preceding vehicle is an abnormally behaving vehicle (S1130: Yes), the control device 100 may determine whether a destination-based route is set (S1150).

In a situation in which a destination-based route is set, a main driving goal is for the vehicle 10 to reach a destination along a specific route, and therefore, if the abnormal behavior of the preceding vehicle interferes with the route, an appropriate avoidance operation may be required (e.g., executing a lane change, merging into a faster lane, or issuing a rerouting command, etc.). Therefore, if the destination-based route is set (S1150: Yes), the control device 100 may control the vehicle 10 so that the vehicle 10 avoids the preceding vehicle (S1160).

On the other hand, if no destination-based route is set (S1150: No), the control device 100 may create the virtual object and display the created virtual object (S1170). Further, the control device 100 may control the vehicle 10 so that the vehicle 10 follows the virtual object (S1180).

The control device 100 may increase a safe distance time (S1190).

The safe distance time may refer to the minimum time interval that allows the vehicle (10) to avoid a collision with the front vehicle (e.g., 2 seconds, 3 seconds, or more depending on traffic speed, etc.).

Since the virtual object is set to have further reduced motion compared to the preceding vehicle, the control device 100 may calculate a headway of the vehicle based on the safe distance time from the preceding vehicle or the virtual object and a relative speed. In other words, the safe distance time may be adjusted for more relaxed or gradual following control relative to the preceding vehicle.

For example, the control device 100 may reset a minimum safe distance criterion between the vehicle 10 and the preceding vehicle to increase the safe distance time, thereby setting control intensity for following the virtual object. In this process, the control device 100 maintains the safe distance by decreasing the speed of the vehicle 10 or executing the braking command (e.g., applying regenerative braking, activating friction brakes, or reducing motor torque, etc.). For example, the distance between the vehicle 10 and the preceding object is typically set to a safe distance corresponding to two seconds, but this may be increased to three or four seconds in a situation in which an abnormal behavior is detected.

Referring to FIG. 12, the control device 100 may determine whether a distance between the preceding object and the vehicle 10 is greater than or equal to a preset minimum distance during the following control with respect to the virtual object in FIG. 11 (S1210). Here, the preceding object may be any one of the preceding vehicle and the virtual object. That is, the control device 100 may determine whether the preceding vehicle is within the minimum distance based on an actual distance to the preceding vehicle or whether the preceding vehicle is within the minimum distance based on an arbitrarily set distance to the virtual object (e.g., using map data, a headway model, or vehicle-to-vehicle communication, etc.).

If the distance between the preceding object and the vehicle 10 is not greater than the preset minimum distance (S1210: No), the control device 100 may change the control target of the vehicle 10 to the preceding vehicle to ensure safety (S1220). In this process, the control device 100 may adjust display states of the preceding vehicle and the virtual object on the display so that the driver recognizes that the current following target has been changed (e.g., through display overlays, icon changes, or system messages, etc.).

For example, when the preceding vehicle and the virtual object are displayed simultaneously on the display, the control device 100 may increase the transparency of the virtual object or delete the virtual object to indicate that the virtual object is no longer followed. On the other hand, the preceding vehicle that has been newly set as the following target may be highlighted (e.g., with an emphasized border or a bright color, increased opacity, or flashing highlights, etc.) or displayed with a low transparency, or a message saying “Current following target: Preceding vehicle” may be output on the display so that the driver can clearly recognize a current situation.

On the other hand, if the distance between the preceding object and the vehicle 10 is greater than or equal to the preset minimum distance (S1210: Yes), the control device 100 may maintain the control of the vehicle 10 so that the vehicle 10 follows an existing virtual object (S1230).

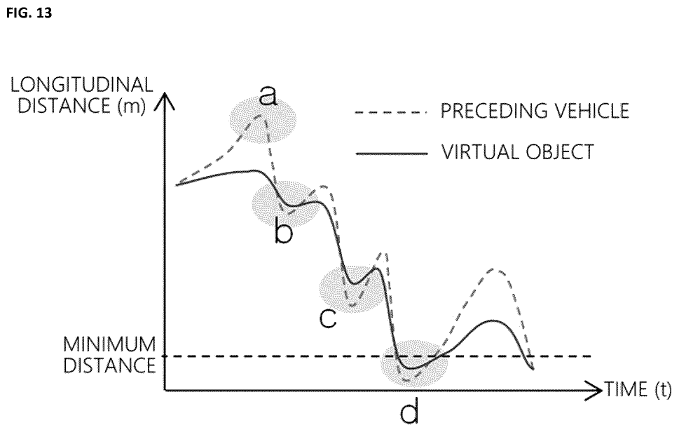

FIG. 13 shows an example of a distance relationship between the preceding vehicle and the virtual object.

In FIG. 13, a case in which the preceding vehicle is an abnormally behaving vehicle is shown, and it is assumed that the vehicle 10 follows the virtual object. In this case, a longitudinal distance between the preceding vehicle and the virtual object over time is shown in a graph form (e.g., plotted on a time-distance axis, with different line styles for each object, etc.). This longitudinal distance may be information on a distance relative to the vehicle 10. The longitudinal distance of the preceding vehicle over time may be indicated by a dotted line, and the longitudinal distance of the virtual object over time may be indicated by a solid line (e.g., to visually distinguish erratic motion from stabilized motion, etc.).

At time a, the preceding vehicle is displayed on the display as being further away from the vehicle 10 than the virtual object. Subsequently, at time b and time c, the preceding vehicle is displayed as being closer to the vehicle 10 than the virtual object due to acceleration and deceleration (e.g., sudden braking, lane cutting, or tailgating, etc.). Then, if the preceding vehicle is within the minimum distance at time d, the control device 100 may control the vehicle 10 so that the vehicle 10 stops following the virtual object and follows the preceding vehicle.

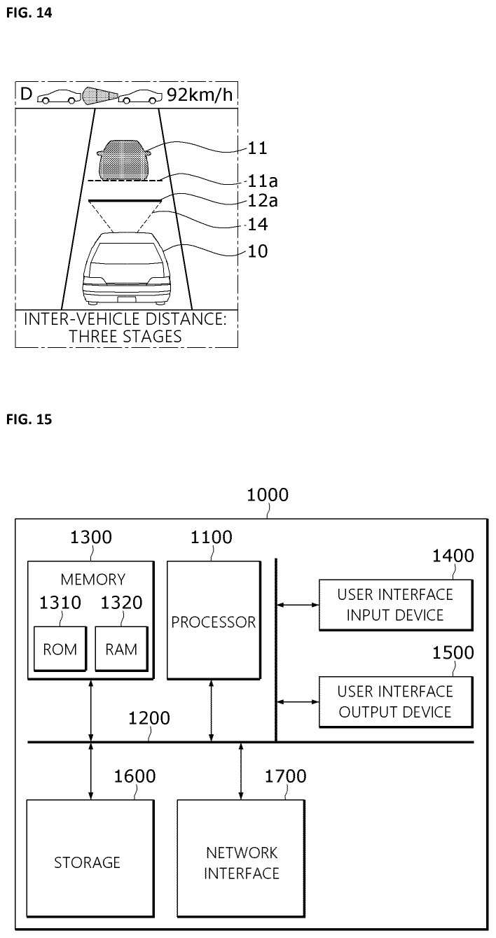

FIG. 14 shows an example of a display screen that is displayed according to an example.

FIG. 14 shows an example of a different screen from the display screens of FIGS. 3 to 10 described above. As described above, in an example of the present disclosure, the vehicle 10, the preceding vehicle 11, and the virtual object 12 may be output in various forms depending on a size, shape, or the like of the display (e.g., rectangular, circular, widescreen, or curved displays, etc.). For example, the illustrated screens of FIGS. 3 to 10 may be output to correspond to the shape and size as in FIG. 14. In FIG. 14, a display screen in which the vehicle 10 follows the partial area 12a of the virtual object is illustrated. When the vehicle 10 follows the preceding vehicle 11, the control device 100 may display the indicator 14 so that the vehicle 10 follows a specific area of the displayed area or the partial area 11a of the preceding vehicle 11 as in FIG. 9 described above (e.g., the rearmost bumper region, the center of the lane marker behind the vehicle, or a calculated centroid, etc.).

FIG. 15 shows an example computing system (e.g., a computing device of a vehicle or any other apparatus). One or more controllers, processors, etc. described herein, such as one or more components of the vehicle 10 or any other components and devices disclosed herein, may be implemented by or in the computing system as shown in FIG. 15.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example example(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to an example of the present disclosure, there is a provided a control device including a memory, and a processor electrically or adaptively connected to the memory, wherein the processor is configured to confirm a preceding vehicle, the preceding vehicle being a target of following control of a vehicle during driving control in an autonomous driving system of the vehicle, create a virtual object associated with the preceding vehicle based on driving information of the confirmed preceding vehicle, and display the preceding vehicle and the created virtual object through a display of the vehicle.

In the control device according to some examples, the processor may be configured to create the virtual object if an abnormal behavior of the preceding vehicle is detected.

In the control device according to some examples, the processor may be configured to create the virtual object if an abnormal behavior of the preceding vehicle is detected for a predetermined time or longer.

In the control device according to some examples, the processor may be configured to control the vehicle so that the vehicle follows any one of the preceding vehicle and the virtual object, and control the display so that the followed object is displayed distinctly on the display.

In the control device according to some examples, the processor may be configured to control the vehicle so that the vehicle follows the virtual object if the preceding vehicle is within a predetermined distance from the vehicle.

In the control device according to some examples, the processor may be configured to control the vehicle so that the vehicle follows the preceding vehicle if the preceding vehicle is within a predetermined distance from the vehicle.

In the control device according to some examples, the processor may be configured to delete the virtual object from the display if the preceding vehicle is within a predetermined distance from the vehicle.

In the control device according to some examples, the processor may be configured to confirm at least one of a change in speed, a change in acceleration, or a change in distance of the preceding vehicle, or detect an abnormal behavior of the preceding vehicle if a confirmation result exceeds a preset value.

In the control device according to some examples, the processor may be configured to output a warning through an input/output interface of the vehicle if an abnormal behavior of the preceding vehicle is detected.

In the control device according to some examples, the processor may be configured to highlight the preceding vehicle through the display if an abnormal behavior of the preceding vehicle is detected.

In the control device according to some examples, the processor may be configured to simultaneously display the preceding vehicle and the virtual object through the display.

In the control device according to some examples, the processor may be configured to display the preceding vehicle and the virtual object in distinct forms on the display.

In the control device according to some examples, the virtual object may be configured to exhibit reduced motion compared to at least one of longitudinal motion or lateral motion of the preceding vehicle.

In the control device according to some examples, the virtual object may be configured to exhibit less motion in a decelerating direction smaller than in an accelerating direction.

According to an example of the present disclosure, there is a provided a method for controlling a vehicle including a display, the method including confirming a preceding vehicle, the preceding vehicle being a target of following control of a vehicle during driving control in an autonomous driving system of the vehicle, creating a virtual object associated with the preceding vehicle based on driving information of the confirmed preceding vehicle, and displaying the preceding vehicle and the created virtual object through the display of the vehicle.

In the method according to some examples, the creating of the virtual object may include creating the virtual object if an abnormal behavior of the preceding vehicle is detected.

In the method according to some examples, the creating of the virtual object may include creating the virtual object if an abnormal behavior of the preceding vehicle is detected for a predetermined time or longer.

The method according to some examples may further include controlling the vehicle so that the vehicle follows any one of the preceding vehicle and the virtual object, and controlling the display so that the followed object is displayed distinctly on the display.

The method according to some examples may further include outputting a warning through an input/output interface of the vehicle if an abnormal behavior of the preceding vehicle is detected.

In the method according to some examples, the displaying of the preceding vehicle and the created virtual object through the display of the vehicle may include displaying the preceding vehicle and the virtual object in distinct forms on the display.

In the examples of the above-described drawings, the driving state of the preceding vehicle may be analyzed in real time, and if an abnormal behavior is detected, the virtual object to replace the preceding vehicle may be created so that the following control of the vehicle can be stably performed.

According to an example of the present disclosure, it is possible to improve the stability of driving of the autonomous driving vehicle by detecting the abnormal behavior of the preceding vehicle in real time and creating the virtual object that replaces the preceding vehicle to stably perform the following control of the vehicle.

The effects of the present disclosure are not limited to the effect mentioned above, and other effects that have not been mentioned can be clearly understood by those skilled in the art from the description below.

Although the present disclosure has been described above with reference to preferred examples of the present disclosure, it will be understood by those skilled in the art that various modifications and changes can be made to the present disclosure without departing from the spirit and scope of the present disclosure set forth in the following claims.

What is claimed is:

1. An apparatus of a vehicle, the apparatus comprising:
a processor; and
a memory storing at least one instruction that, when executed by the processor communicating with the memory, is configured to cause the apparatus to:
identify, via a sensor of the vehicle, a preceding vehicle, wherein the preceding vehicle corresponds to a target object for the vehicle to follow during autonomous driving of the vehicle,
create, based on driving information of the identified preceding vehicle, a virtual object associated with the preceding vehicle,
output a signal indicating the preceding vehicle and the created virtual object, and
control, based on the signal, autonomous driving of the vehicle.

2. The apparatus of claim 1, wherein the at least one instruction, when executed by the processor communicating with the memory, is configured to cause the apparatus to create, based on a determination that the preceding vehicle is abnormally behaving, the virtual object.

3. The apparatus of claim 1, wherein the at least one instruction, when executed by the processor communicating with the memory, is configured to cause the apparatus to, based on a determination that the preceding vehicle is abnormally behaving for a predetermined time or longer, create the virtual object.

4. The apparatus of claim 1, wherein the at least one instruction, when executed by the processor communicating with the memory, is configured to cause the apparatus to:
control the vehicle so that one of the preceding vehicle or the virtual object is followed by the vehicle, and
control a display of the vehicle so that the one of the preceding vehicle or the virtual object followed by the vehicle and an indicator indicating that the one of the preceding vehicle or the virtual object is a current following target of the vehicle are is displayed on the display.

5. The apparatus of claim 1, wherein the at least one instruction, when executed by the processor communicating with the memory, is configured to cause the apparatus to, based on the preceding vehicle being a predetermined distance away from the vehicle, control the vehicle so that the vehicle follows the virtual object.

6. The apparatus of claim 1, wherein the at least one instruction, when executed by the processor communicating with the memory, is configured to cause the apparatus to, based on the preceding vehicle being within a predetermined distance from the vehicle, control the vehicle so that the vehicle follows the preceding vehicle.

7. The apparatus of claim 1, wherein the at least one instruction, when executed by the processor communicating with the memory, is configured to cause the apparatus to, based on the preceding vehicle being within a predetermined distance from the vehicle, delete the virtual object.

8. The apparatus of claim 7, wherein the at least one instruction, when executed by the processor communicating with the memory, is configured to cause the apparatus to:
detect at least one of:
a change in speed of the preceding vehicle,
a change in acceleration of the preceding vehicle, or
a change in distance between the vehicle and the preceding vehicle, and
determine, based on the at least one of the detected changes exceeding a preset value, that the preceding vehicle is abnormally behaving.

9. The apparatus of claim 1, wherein the least one instruction, when executed by the processor communicating with the memory, is configured to cause the apparatus to, based on a determination that the vehicle is abnormally behaving, output a warning through a user interface of the vehicle.

10. The apparatus of claim 1, wherein the at least one instruction, when executed by the processor communicating with the memory, is configured to cause the apparatus to, based on a determination that the vehicle is abnormally behaving, highlight the preceding vehicle on a display of the vehicle.

11. The apparatus of claim 1, wherein the least one instruction, when executed by the processor communicating with the memory, is configured to cause the apparatus to simultaneously display, on a display of the vehicle, the preceding vehicle and the virtual object.

12. The apparatus of claim 1, wherein the least one instruction, when executed by the processor communicating with the memory, is configured to cause the apparatus to display, on a display of the vehicle, the preceding vehicle and the virtual object in distinct forms.

13. The apparatus of claim 1, wherein the virtual object is configured to exhibit reduced motion of the preceding vehicle with respect to at least one of longitudinal motion or lateral motion of the preceding vehicle.

14. The apparatus of claim 13, wherein the virtual object is configured to exhibit less motion in a decelerating direction of the preceding vehicle than in an accelerating direction of the preceding vehicle.

15. A method performed by an apparatus of a vehicle, the method comprising:
identifying, via a sensor of the vehicle, a preceding vehicle, wherein the preceding vehicle corresponds to a target object for the vehicle to follow during autonomous driving of the vehicle;
creating, based on driving information of the identified preceding vehicle, a virtual object associated with the preceding vehicle;
outputting a signal indicating the preceding vehicle and the created virtual object; and
controlling, based on the signal, autonomous driving of the vehicle.

16. The method of claim 15, wherein the creating of the virtual object comprises, based on a determination that the preceding vehicle is abnormally behaving, creating the virtual object.

17. The method of claim 15, wherein the creating of the virtual object comprises, based on a determination that the preceding vehicle is abnormally behaving for a predetermined time or longer, creating the virtual object.

18. The method of claim 15, further comprising:
controlling the vehicle so that one of the preceding vehicle and the virtual object is followed by the vehicle; and
controlling a display of the vehicle so that the one of the preceding vehicle or the virtual object followed by the vehicle and an indicator indicating that the one of the preceding vehicle or the virtual object is a current following target of the vehicle are displayed on the display.

19. A vehicle, the apparatus comprising:
a sensor configured to detect at least one external vehicles;
a processor; and
a memory storing at least one instruction that, when executed by the processor communicating with the memory, is configured to cause the vehicle to:
identify, via the sensor, a preceding vehicle that is being autonomously followed by the vehicle,
determine, based on driving information of the preceding vehicle, whether the preceding vehicle exhibits driving behavior that satisfies a condition,
based on the driving behaving satisfying the condition, output a signal indicating a virtual vehicle object associated with the preceding vehicle, and
based on the signal, switch control of autonomous driving of the vehicle from following the preceding vehicle to following the virtual vehicle object.

20. The vehicle of claim 19, wherein the virtual vehicle object is configured to exhibit reduced motion compared to at least one of a longitudinal motion or a lateral motion of the preceding vehicle, such that controlling the autonomous driving of the vehicle to follow the virtual vehicle object results in reduced acceleration or deceleration of the vehicle.
